(19) United States
(12) Patent Application Publication
(10) Pub. No.: US 2003/0055157 A1
(43) Pub. Date: Mar. 20, 2003

(54) Silicone rubber composition for producing cables or profiles with retention of function in the event of fire

(75) Inventors: Dietrich Wolfer, St. Georgen-Oberndorf (AU); Wilhelm Marsch, Haiming (DE); Werner Brennenstuhl, Burgkirchen (DE)

Correspondence Address: BROOKS & KUSHMAN, 1000 TOWN CENTER 22ND FL, SOUTHFIELD, MI, 48075

(73) Assignee: WACKER-CHEMIE GmbH, Munich (DE)

(21) Appl. No.: 10/238,663

(22) Filed: Sep. 10, 2002

(30) Foreign Application Priority Data
Sep. 20, 2001 (DE) 101 46 392.8

(51) Int. Cl. C08L 83/00

(52) U.S. Cl. 524/588

(57) ABSTRACT

A composition comprising peroxidically crosslinking condensation-crosslinking, or addition-crosslinking silicone rubber; metal compounds selected from metal oxides such as magnesium oxide, aluminum oxide, tin oxide, calcium oxide and barium oxide and precursors thereof which produce oxides on heating, boric acid, and zinc borate; platinum complexes having at least one unsaturated group; and hollow beads. The compositions form a coherent ceramic insulation upon heating which still enables the conductors to carry high voltage electrical signals.

### BACKGROUND OF THE INVENTION

1. Field of the Invention

The invention relates to silicone rubber compositions which allow retention of function of cables insulated therewith in the event of fire, and to a process for preparation thereof.

2. Background Art

DE-A-19 855 912 and DE-A-30 08 084 disclose ceramifying silicone compositions containing a silicone rubber composition, metal oxide, and platinum compounds. However, these silicone rubbers are unsuitable for high-frequency applications and their fire performance remains unsatisfactory.

### SUMMARY OF THE INVENTION

The present invention provides a silicone rubber cable insulation material which overcomes disadvantage(s) of the prior art. These and other objects are achieved by the invention.

### DETAILED DESCRIPTION OF THE PREFERRED EMBODIMENTS

The invention provides a composition comprising peroxidically crosslinking, condensation-crosslinking, or addition-crosslinking silicone rubber; metal oxides selected from among magnesium oxide, aluminum oxide, tin oxide, calcium oxide, titanium dioxide, barium oxide, metal compounds which produce oxides on heating, boric acid, and zinc borate; platinum complexes having at least one unsaturated group; and hollow beads.

The novel silicone rubber is preferably a peroxidically crosslinking organopolysiloxane composition, for example one which preferably comprises the following components.

Organopolysiloxanes containing units of the general formula

$${R}_{r} S i {O}_{\frac{4 - r}{2}}$$

where

R are identical or different unsubstituted or substituted (“optionally substituted”) hydrocarbon radicals,

r is 0, 1, 2 or 3 and has an average numerical value of from 1.9 to 2.1.

Examples of hydrocarbon radicals R are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, octadecyl radicals such as the n-octadecyl radical; cycloalkyl radicals such as cyclopentyl, cyclohexyl, cycloheptyl, and methylcyclohexyl radicals; aryl radicals such as the phenyl, biphenyl, naphthyl, anthryl, and phenanthryl radicals; alkaryl radicals such as o-, m- or p-tolyl radicals, xylyl radicals and ethylphenyl radicals; and aralkyl radicals such as the benzyl radical and the α- and the β-phenylethyl radical.

Examples of substituted hydrocarbon radicals R are halogenated alkyl radicals such as the 3-chloropropyl radical, the 3,3,3-trifluoropropyl radical and the perfluorohexylethyl radical, and halogenated aryl radicals such as the p-chlorophenyl radical and the p-chlorobenzyl radical.

The radicals R are preferably hydrogen atoms or hydrocarbon radicals having from 1 to 8 carbon atoms, most preferably the methyl radical.

Other examples of radicals R are the vinyl, allyl, methallyl, 1-propenyl, 1-butenyl and 1-pentenyl radicals, and the 5-hexenyl, butadienyl, hexadienyl, cyclopentenyl, cyclopentadienyl, cyclohexenyl, ethynyl, propargyl and 1-propynyl radicals, preferably alkenyl radicals having from 2 to 8 carbon atoms, most preferably the vinyl radical.

Among unsubstituted or substituted hydrocarbon radicals having from 1 to 8 carbon atoms particular preference is given to the methyl, vinyl, phenyl and 3,3,3-trifluoropropyl radicals.

It is preferable for there to be alkyl radicals, in particular methyl radicals, bonded to at least 70 mol % of the Si atoms present in the organopolysiloxane (A) composed of units of the formula (I). If the organopolysiloxanes contain Si-bonded vinyl and/or phenyl radicals in addition to Si-bonded methyl and/or 3,3,3-trifluoropropyl radicals, the amounts of the former are preferably from 0.001 to 30 mol %.

The organopolysiloxanes are preferably composed predominantly of diorganosiloxane units. The end groups of the organopolysiloxanes may be trialkylsiloxy groups, in particular the trimethylsiloxy radical or the dimethylvinylsiloxy radical. However, it is also possible for one or more of these alkyl groups to have been replaced by hydroxy groups, or by alkoxy groups such as methoxy or ethoxy radicals.

The organopolysiloxanes may be liquids or high-viscosity substances. The organopolysiloxanes preferably have a viscosity of from 10³ to 10⁸ mm²/s at 25° C.

The crosslinking agents used in the novel silicone rubber compositions preferably comprise peroxides such as dibenzoyl peroxide, bis(2,4-dichlorobenzoyl)peroxide, dicumyl peroxide or 2,5-bis(tert-butylperoxy)-2,5-dimethylhexane, or mixtures of these, preferably bis(2,4-dichlorobenzoyl) peroxide or 2,5-bis(tert-butylperoxy)-2,5-dimethyl-hexane. Preference is also given to the use of a crosslinking agent comprising a mixture of bis(4-methylbenzoyl)peroxide (“PMBP”) and 2,5-dimethylhexane-2,5-di-tert-butyl peroxide (“DHBP”) in a ratio of from 1:0.4 to 0.5:1, preferably in a ratio of about 1:0.4.

The organopolysiloxanes preferably also comprise reinforcing and/or non-reinforcing fillers. Examples of reinforcing fillers are pyrogenic or precipitated silicas with BET surface areas of at least 50 m²/g. The silica fillers may have hydrophilic properties or may have been hydrophobicized by known processes. Reference may be made to DE 38 39 900 A (Wacker-Chemie GmbH; application date Nov. 25, 1988), or to the corresponding U.S. Pat. No. 5,057,151, for example. In such cases the hydrophobicization is generally carried out using from 1 to 20% by weight of hexamethyldisilazane and/or divinyltetramethyldisilazane and from 0.5 to 5% by weight of water, based in each case on the total weight of the organopolysiloxane composition. These reagents are advantageously fed to a suitable mixing apparatus, e.g. a kneader or internal mixer, in which there is an initial charge of the organopolysiloxane, prior to gradual incorporation of the hydrophilic silica into the composition.

Examples of non-reinforcing fillers are powdered quartz, diatomaceous earth, calcium silicate, zirconium silicate, zeolites, metal oxide powders such as aluminum oxide, titanium oxide, iron oxide or zinc oxide, barium silicate, barium sulfate, calcium carbonate, gypsum, and also synthetic polymer powders such as polyacrylonitrile powder or polytetrafluoroethylene powder. The fillers used may also comprise fibrous components, such as glass fibers or synthetic polymer fibers. The BET surface area of these fillers is preferably less than 50 m²/g.

The amounts of filler present in the novel organopolysiloxane compositions which can be crosslinked to give elastomers are preferably from 1 to 200 parts by weight, more preferably from 30 to 100 parts by weight, based in each case on 100 parts by weight of organopolysiloxane.

Depending on the particular application, additives such as workability aids, for example plasticizers, pigments or stabilizers, e.g. heat stabilizers, may be added to the novel organopolysiloxane compositions which can be vulcanized to give elastomers.

Examples of plasticizers which may be used as additives are polydimethylsiloxanes terminated by trimethylsilyl groups or by hydroxy groups, having a viscosity of not more than 1000 mm²/s at 25° C. Diphenylsilanediol is also a suitable plasticizer.

Examples of heat stabilizers which may be used as additives are transition metal salts of fatty acids such as iron octoate, transition metal silanolates such as iron silanolate, and cerium(IV) compounds.

The novel compositions preferably comprise no substances other than those mentioned herein. Each of the components used to prepare the novel compositions may be one single type of the respective component, or a mixture of two or more different types of that component.

The silicone rubber compositions used may also be a conventional condensation-crosslinking organopolysiloxane, as described, for example, in EP 0 359 251, which is incorporated herein by way of reference, or known addition-crosslinking RTV or HTV compositions, as described in EP 0355459 B1, which is hereby incorporated by reference.

An example of preparation of an addition-crosslinked HTV silicone rubber is as follows. 75 parts of a diorganopolysiloxane end-capped by trimethylsiloxy groups and composed of 99.7 mol % of dimethylsiloxane units and 0.3 mol % of vinylmethoxysilane units, with a viscosity of 8×10⁶ mpa·s at 25° C., and 25 parts of a diorganopolysiloxane end-capped by trimethylsiloxy groups and composed of 99.4 mol % of dimethylsiloxane units and 0.6 mol % of vinylmethylsiloxane units, with a viscosity of 8×10⁶ mpa·s at 25° C., are mixed and kneaded for 2 hours in a kneader operated at 150° C., with 45 parts of silicon dioxide produced pyrogenically in the gas phase, with a BET surface area of 300 m²/g, and 7 parts of a dimethylpolysiloxane having an Si-bonded hydroxy group in each terminal unit, with a viscosity of 40 mpa·s at 25° C.

The novel composition also comprises metal oxides preferably selected from among magnesium oxide, aluminum oxide, tin oxide, calcium oxide, titanium dioxide and barium oxide, metal compounds of these elements which give oxides on heating, for example hydroxides, boric acid, or zinc borate, in amounts of from 1.5 to 40% by weight based on the total weight of the composition, preferably from 10 to 20% by weight. Mixtures of these compounds may also be used. Metal compounds which form metal oxides upon heating may be termed metal oxide “precursors.”

The novel compositions further comprise platinum complexes which have at least one unsaturated group, preferably for example platinum-olefin complexes, platinum-aldehyde complexes, platinum-ketone complexes, platinum-vinylsiloxane complexes or platinum-1,3-divinyl-1,1,3,3-tetramethyldisiloxane complexes with or without any detectable content of organic halogen, platinum-norbornadiene-methylacetonate complexes, bis-(gamma-picoline)platinum dichloride, trimethylenedipyridineplatinum dichloride, dicyclopentadieneplatinum dichloride, (dimethylsulfoxide)(ethylene)platinum(II) dichloride, reaction products of platinum tetrachloride with olefin and with primary amine, with secondary amine, or with primary and secondary amine, a reaction product of sec-butylamine with platinum tetrachloride dissolved in 1-octene, particularly preferably the platinum-1,3-divinyl-1,1,3,3-tetramethyldisiloxane complex. The amount of the platinum complex used is preferably from 5 to 200 ppm, more preferably from 10 to 100 ppm. The amount is based on elemental platinum. It is also possible to use mixtures of the platinum complexes.

The hollow beads employed in the compositions of the invention include hollow glass beads, hollow silica beads, hollow metal beads, or more preferably, hollow polymer beads, i.e., those composed of elastomers or of a thermoplastic material.

Preferred hollow polymer beads are organic polymer-based microballoons, e.g., prepared from polymers such as polyvinyl chlorides, polyvinyl acetates, polyesters, polycarbonates, polyethylenes, polystyrenes, polymethyl meth-acrylates, polyvinyl alcohols, ethylcellulose, nitrocellulose, benzylcellulose, epoxy resins, hydroxypropylmethylcellulose phthalate, copolymers of vinyl chloride and vinyl acetate, copolymers of vinyl acetate and cellulose acetate butyrate, copolymers of styrene and maleic acid, copolymers of acrylonitrile and styrene, copolymers of vinylidene chloride and acrylonitrile, and the like. Processes for producing hollow polymer bodies of this type are known, and these processes are described in particular in EP-B 348 372 (CASCO NOBEL AG) and in the references cited therein: U.S. Pat. No. 3,615,972, U.S. Pat. No. 4,397,799 and EP-A-112807.

Preference is given to expanded and, with particular preference, expandable hollow polymer microballoons with diameters of from 1 to 800 μm, preferably from 5 to 100 μm, most preferably from 10 to 16 μm. The density in air is preferably from 10 to 100 kg/m³, more preferably from 20 to 80 kg/m³, and most preferably from 20 to 60 kg/m³. Particular preference is given to the hollow microballoons with the trade name Expancel 053, 091, 092 DU, products of Expancel Nobel Industries. The expandable hollow bodies comprise an expansion gas or “blowing agent,” e.g. butane or isobutane. The amount of these hollow polymer bodies used is preferably from 2 to 20% by weight, with greater preference from 4 to 12% by weight, and most preferably from 5 to 8% by weight, based on the entire composition weight.

The invention also provides a process for preparing the novel composition by mixing all of the abovementioned components.

The invention provides cables and profiles which comprise the novel composition. The cables are preferably communications or energy cables, or else a cable in which the voids between at least two insulated conductors have been filled with the composition of the invention. The profiles comprise silicone foams or compact gaskets for fire-resistant screening for rooms, cabinets or safes, or else ablation materials for lining rocket engines, etc. The silicone rubber composition of the invention may moreover be used as a ceramifiable RTV foam i.e., a foam which crosslinks at room temperature.

Surprisingly, the present invention permits sintering to start at temperatures as low as 650° C., leading to the formation of a ceramic layer of the combustion products of silicone rubber. Thus, it is possible to prepare silicone rubber mixtures with a low specific gravity (preferably about 0.41) but with almost the same mechanical, electrical and heat-ageing properties as normal ceramifiable silicone rubber with a much higher specific density of 1.25, for applications which require retention of function in the event of fire. Surprisingly, the compositions of the invention achieve better thermal insulation and higher insulation capability, especially in the temperature range above 900° C., than conventional silicone rubber compositions. The ceramic material formed in the event of fire is moreover significantly more resistant to impact and shock than are the mixtures described in the prior art, which merely form a stable ash layer. Surprisingly, when comparison is made with conventional silicone rubber compositions without hollow bodies the dielectric constant is now 1.8, instead of 2.7. This permits extension of the use of these silicone rubber compositions to the high-frequency sector, in particular in antenna cables in the high-frequency sector, e.g. in mobile radio.

### EXAMPLE 1

100 parts of a diorganopolysiloxane end-capped by trimethylsiloxy groups, composed of 99.93 mol percent of dimethylsiloxane units and 0.07 mol percent of vinylmethylsiloxane units and having a viscosity of 8·10⁶ mpPa·s at 25° C. are mixed in a kneader operated at 150° C., firstly with 50 parts of silicon dioxide produced pyrogenically in the gas phase and having a surface area of 200 m²/g, then with 1 part of dimethylpolysiloxane end-capped by trimethylsiloxy groups and having a viscosity of 96 mPa·s at 25° C., and then with 7 parts of a dimethylpolysiloxane having a Si-bonded hydroxy group in each terminal unit and having a viscosity of 40 mpa·s at 25° C., and with 36 parts of aluminum oxide having a particle size >10 μm and having an alkali metal oxide content of <0.5% by weight, and also 0.3% by weight of a platinum-1,3-divinyl-1,1,3,3-tetramethyl-disoloxane complex and 8 g of hollow polymer beads (made from an isobutane-filled acrylonitrile copolymer).

### COMPARATIVE EXAMPLE 2

The method described in Example 1 is repeated, except that no platinum complex is added.

### COMPARATIVE EXAMPLE 3

The method described in Example 2 is repeated except that no aluminum oxide is added.

### COMPARATIVE EXAMPLE 4

The method described in Example 1 is repeated except that no hollow polymer beads are added.

### Specimen From Example 1

The cable insulation ignites at about 420° C. and burns, thereby forming a solid, porous ceramic layer. During the two hours at 1100° C. the potential of 500 Volts continues to be applied without any short-circuiting. The potential can be raised to 1000 Volts without short-circuiting.

### Specimen From Comparative Example 2

The cable ignites at 420° C. and burns, thereby forming a coherent, porous ash layer but this then falls away before 930° C. is reached, and therefore the thermal expansion of the wires causes them to touch and thus create a short circuit.

### Specimen From Comparative Example 3

The cable ignites at 420° C. and then burns, thereby forming a pulverulent, porous ash layer which falls away as the fire continues, and shortly afterward a short circuit is created.

### Specimen From Comparative Example 4

Once the cable insulation has been ignited at 420° C. it burns and forms a solid ceramic layer. During the 2 hours at about 1000° C. the potential of 500 Volts continues to be applied without any short-circuiting. However, during the burning of the insulation occasional small cracks have arisen in the ceramic layer, due to thermal expansion of the copper conductor. When the potential is raised to 1000 V, electrical breakdown and short-circuiting occurs.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A composition comprising at least one peroxidically crosslinking, condensation-crosslinking or addition-crosslinking silicone rubber; at least one metal compound component selected from the group consisting of magnesium oxide, aluminum oxide, tin oxide, calcium oxide, barium oxide, metal oxide precursors thereof, boric acid, zinc borate, and mixtures thereof; at least one platinum complex containing at least one unsaturated group; and hollow beads.

2. The composition of claim 1, wherein the platinum complex is a platinum-vinylsiloxane complex.

3. The composition of claim 2, wherein the platinum-vinylsiloxane complex is a platinum-1,3-divinyl-1,1,3,3-tetramethyldisiloxane complex.

4. The composition of claim 1, wherein the hollow beads are expandable hollow beads.

5. A process for preparing the composition of claim 1, comprising mixing the components.

6. A cable comprising at least one conductor and at least one portion of insulation, wherein said portion of insulation comprises the composition of claim 1.

7. The cable of claim 6, wherein voids between at least two insulated conductors contain the composition of claim 1.

8. A profile which comprises the composition of claim 1.

9. The profile of claim 8 which is an elastomeric gasket or sealing device.
